(19) United States
(12) Patent Application Publication
(10) Pub. No.: US 2024/0368356 A1
(43) Pub. Date: Nov. 7, 2024

(54) SMALL-PARTICLE SIZE POLYMERIC CHELATORS

(71) Applicant: THE UNIVERSITY OF KANSAS, Lawrence, KS (US)

(72) Inventors: Cory BERKLAND, St. Louis, MO (US); Jian QIAN, Belle Mead, NJ (US)

(21) Appl. No.: 18/683,230

(22) PCT Filed: Aug. 12, 2022
(86) PCT No.: PCT/US22/40247

§ 371 Date: Feb. 12, 2024

Related U.S. Application Data
(60) Provisional application No. 63/233,022, filed on Aug. 13, 2021.
(60) Provisional application No. 63/316,810, filed on Mar. 4, 2022.

(51) Int. Cl. C08J 3/12; C08F 8/00; C08J 3/075; C08J 3/24

(52) U.S. Cl. CPC C08J 3/12; C08F 8/00; C08J 3/075; C08J 3/24; C08J 2339/00

(57) ABSTRACT

Compositions and methods for making a composition comprising a plurality of polymeric chelator particles comprising a plurality of cross-linked polyamine polymer backbone chains and one or more chelators covalently coupled thereto, wherein at least 90% of the plurality of the polymeric chelator particles have a particle size of 300 μm or less. Also disclosed are methods of using the composition, e.g., for removing metal from a medium or treating iron overload disease.

### CROSS REFERENCE TO RELATED APPLICATIONS

The present application claims priority to U.S. Provisional Application No. 63/233,022, filed Aug. 13, 2021; and claims priority to U.S. Provisional Application No. 63/316,810, filed Mar. 4, 2022, the entirety of which are incorporated herein by reference.

### BACKGROUND

Metals such as cadmium, lead, and arsenic are highly toxic to living organisms. Wastewater discharge may be a primary source of heavy metal release into the environment. The removal of heavy metal ions from industrial wastewater has been given much attention in the last decade, because such components can accumulate in living organisms. Upon their accumulation in the human body, these toxic metals may cause kidney failure, nerve system damage, and bone damage, as well as other serious diseases. The necessity to reduce the amount of heavy metal ions from the environment has led to an increasing interest in technologies that selectively remove such toxic metals.

There are 35 metals that are of concern because of occupational or residential exposure; 23 of these are the heavy elements or “heavy metals.” Heavy metals are chemical elements with a specific gravity that is at least 5 times the specific gravity of water. Small amounts of these elements are common in our environment and diet and in some cases are actually necessary for good health, but large amounts of any of them may cause acute or chronic toxicity. Heavy metal toxicity can result in damaged or reduced mental and central nervous function, lower energy levels, and damage to blood composition, lungs, kidneys, liver, and other vital organs. Long-term exposure may result in slowly progressing physical, muscular, and neurological degenerative processes that mimic Alzheimer's disease, Parkinson's disease, muscular dystrophy, and multiple sclerosis. Allergies are not uncommon and repeated long-term contact with some metals or their compounds may even cause cancer.

A particular heavy metal of concern is iron. Iron is an essential and ubiquitous element in all forms of life involved in a multitude of biological processes and essential for many critical human biological processes. Yet, the presence of excess iron in the body may lead to toxic effects.

Iron overload is a serious complication in patients that have β-thalassemia and is the focal point of its management. In patients that do not receive transfusions, abnormal iron absorption can produce an increase in the body iron burden, which is evaluated to be in the 2-5 gram per year range. Patients that receive treatments that include regular blood transfusions can lead to double this amount of iron accumulation. Iron accumulation introduces progressive damage in liver, heart, and in the endocrine system if left untreated. The available iron is deposited in parenchymal tissues and in reticuloendothelial cells. When the iron load increases, the iron binding capacity of serum transferrin is exceeded and a non-transferrin-bound fraction of plasma iron (NTBI) appears. The NTBI can generate free hydroxyl radicals and induces dangerous tissue damage. Iron accumulates at different rates in various organs, each of which react in a characteristic way to the damage induced by NTBI and by the intracellular labile iron pool (LIP).

Current treatments for iron overload diseases include chelation therapy to chelate the iron and reduce its bioavailability. In one example, chelation therapy can be performed with desferoxamine (DFO), which is administered by subcutaneous infusion. Drugs that can be administered orally include deferiprone and Exjade. DFO therapy has reportedly been associated with several drawbacks including a narrow therapeutic window and lack of oral bioavailability. As a result, it requires administration for 8-12 hours per day by infusion. DFO is not readily absorbed through the intestine and must be injected intravenously thus, is not an ideal chelator since systemic side effects have been reported. Furthermore, concerns have arisen over its use due to numerous significant drug-related toxicities. Serious adverse effects such as neutropenia, agranulocytosis, hypersensitivity reactions, and blood vessel inflammation have also been reported upon the oral application of deferiprone and Exjade.

One possible method of avoiding the use of systemic iron chelators is to inhibit iron absorption from the gastrointestinal tract by orally available, non-absorbed iron chelators that selectively sequester and remove excess dietary iron from the GI tract. Non-absorbed polymer therapies that act by sequestering a number of undesired ionic species in the gastrointestinal tract have been successful clinically. Using non-absorbed polymer therapies is particularly relevant to thalassemia intermedia and hemochromatosis. Iron binding polymers have considerable potential in this therapeutic approach as they can effectively bind iron to form nontoxic, inert complexes that are not absorbed by the gastrointestinal tract, thereby reducing the absorption of iron from the intestine.

Microorganisms have developed a sophisticated Fe(III) acquisition and transport systems involving siderophores. Siderophores are low molecular weight chelating agents that bind Fe(III) ion with high specificity. The iron binding affinity of siderophores dramatically exceeds that of iron chelating therapeutics currently available. Enterobactin, a naturally occurring tris-catechol siderophore, is the most powerful Fe(III) chelator known with a relative iron binding constant of 35.5. Since nearly all iron is absorbed in the gastrointestinal tract, next generation iron chelators must achieve significantly higher iron binding and selectivity with low toxicity and side effects. Researchers have synthesized small molecule siderophore mimetics; however, compounds that directly mimic siderophores would be expected to enhance bacterial recruitment of iron. What is needed is a novel iron chelator that binds iron tightly and removes it from the body.

### SUMMARY

Provided is a composition comprising: a plurality of polymeric chelator particles each comprising a plurality of polyamine polymer backbone chains and one or more chelators, wherein at least 90% (e.g., at least 95% or at least 99%) of the plurality the polymeric chelator have a particle size of 300 μm or less (e.g., as measured by laser diffraction), wherein the one or more chelators are covalently coupled to one or more primary and/or secondary amines (e.g., one or more primary amines) of at least one of the plurality of polyamine polymer backbone chains, and wherein the plurality of polyamine polymer backbone chains are cross-linked with a plurality of cross-linkers. Embodiments include the following alone or in any combination.

The composition wherein at least 90% (e.g., at least 95% or at least 99%) of the plurality of polymeric chelator particles have a particle size of 2 μm to 300 μm (e.g., as measured by laser diffraction).

The composition wherein at least 90% (e.g., at least 95% or at least 99%) of the plurality of polymeric chelator particles have a particle size of 4 μm to 200 μm (e.g., as measured by laser diffraction). The composition wherein at least 90% (e.g., at least 95% or at least 99%) of the plurality of polymeric chelator particles have a particle size of 4 μm to 150 μm (e.g., as measured by laser diffraction).

The composition wherein at least 90% (e.g., at least 95% or at least 99%) of the plurality of polymeric chelator particles have a particle size of 5 μm to 100 μm (e.g., as measured by laser diffraction).

The composition wherein at least 90% (e.g., at least 95% or at least 99%) of the plurality of polymeric chelator particles have a particle size of 18 μm to 70 μm (e.g., as measured by laser diffraction).

The composition where each of the plurality of polyamine polymer backbone chains comprises a polyamine polymer having a molecular weight (weight average molecular weight; “M_{w}”) of 1-50 kDa (e.g., 2-30 kDa, 5-25 kDa, 10-20 kDa, 2, 1 kDa, 2 kDa, 3 kDa, 4 kDa, 5 kDa, 10 kDa, 15 kDa, 20 kDa, 25 kDa, 30 kDa, 35 kDa, 40 kDa, 45 kDa, or 50 kDa).

The composition wherein the polyamine polymer comprises repeating monomeric units each having the structure:

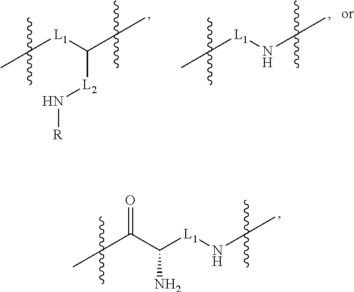

wherein L₁ is C₁-C₆alkylene, L₂ is a bond or C₁-C₆alkylene, and R is H or C(O) R″ in which R″ is H, C₁-C₆ alkyl, or C₆-C₁₂ aryl. As used herein, “alkylene” refers to a divalent, straight-chained or branched, saturated hydrocarbon radical. As used herein, “alkyl” refers to a branched or straight-chain monovalent saturated aliphatic radical containing only C and H when unsubstituted. The term “aryl” as used herein, refers to any monocyclic or fused ring bicyclic system containing only carbon atoms in the ring(s), which has the characteristics of aromaticity in terms of electron distribution throughout the ring system.

The composition wherein the plurality of polyamine polymer backbone chains each comprise polyallylamine.

The composition wherein the plurality of polymer backbone chains each comprise poly(L-lysine).

The composition wherein each of the plurality of cross-linkers is independently of structure:

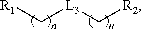

wherein R₁ and R₂ are independently selected from:

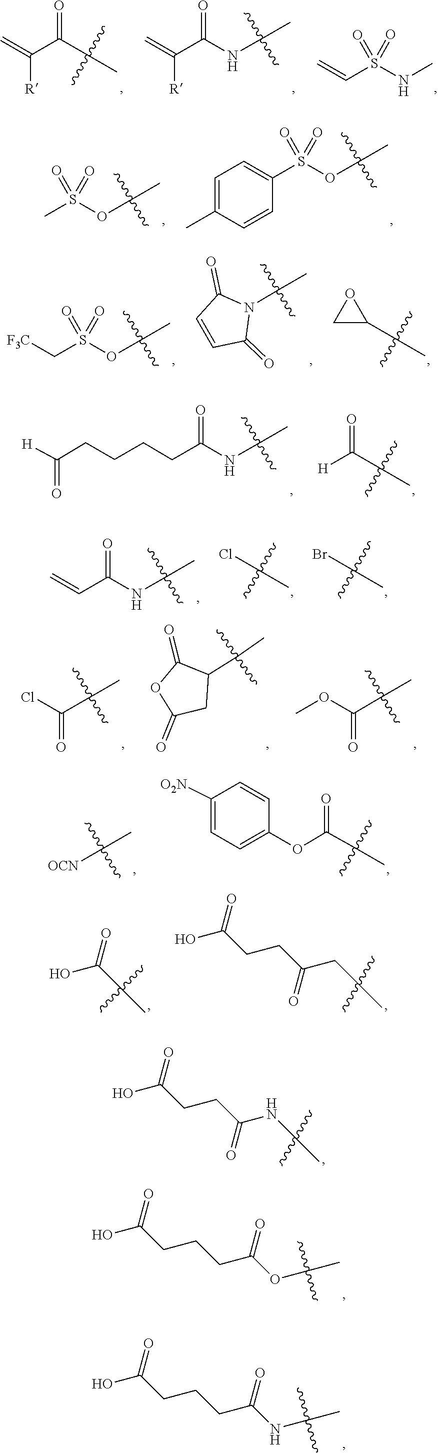

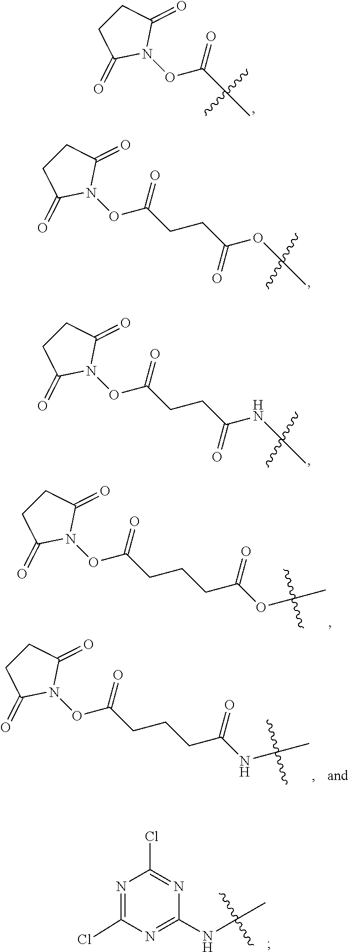 [SMILES: *C(=O)ON1C(=O)CCC1=O ; *OC(=O)CCC(=O)ON1C(=O)CCC1=O ; *NC(=O)CCC(=O)ON1C(=O)CCC1=O ; *OC(=O)CCCC(=O)ON1C(=O)CCC1=O ; *NC(=O)CCCC(=O)ON1C(=O)CCC1=O ; *Nc1nc(Cl)nc(CCl)n1]

R′ is C₁-C₆alkyl; n is 0, 1, or 2; and L₃ is a bond, C₁-C₆alkylene, C₁-C₆heteroalkylene, C₃-C₈cycloalkylene, C₆-C₁₄arylene, or 5- or 6-membered heterocyclylene or polyethylene glycol. As used herein, “heteroalkylene” refers to a divalent, straight-chain or branched hydrocarbon radical in which one or more carbon atoms is replaced with a heteroatom (e.g., O, N, or S); “cycloalkylene” refers to a divalent, monocyclic hydrocarbon radical; “arylene” refers to a divalent, monocyclic, bicyclic, or multicyclic aromatic hydrocarbon radical; and “heterocyclylene” refers to a divalent, aromatic radical containing 1, 2, 3, or 4 heteroatoms as within the ring, and carbon atoms as the remaining ring atoms.

The composition wherein each of the plurality of cross-linkers is N,N′-methylenebisacrylamide.

The composition wherein the polyamine polymer backbone chains comprise polyallylamine and the cross-linker comprises N,N′-methylenebisacrylamide.

The composition wherein the polymeric chelator particles each include at least one group having the structure:

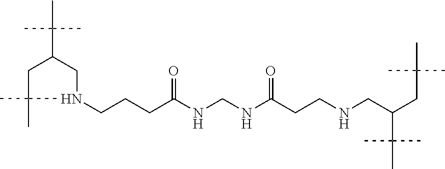

The composition wherein each of the plurality of cross-linkers is selected from:

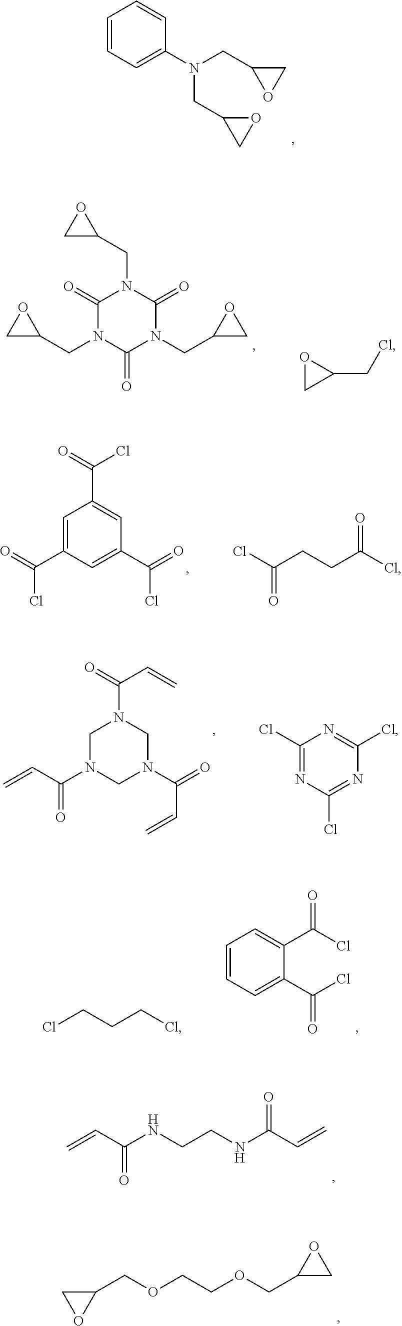

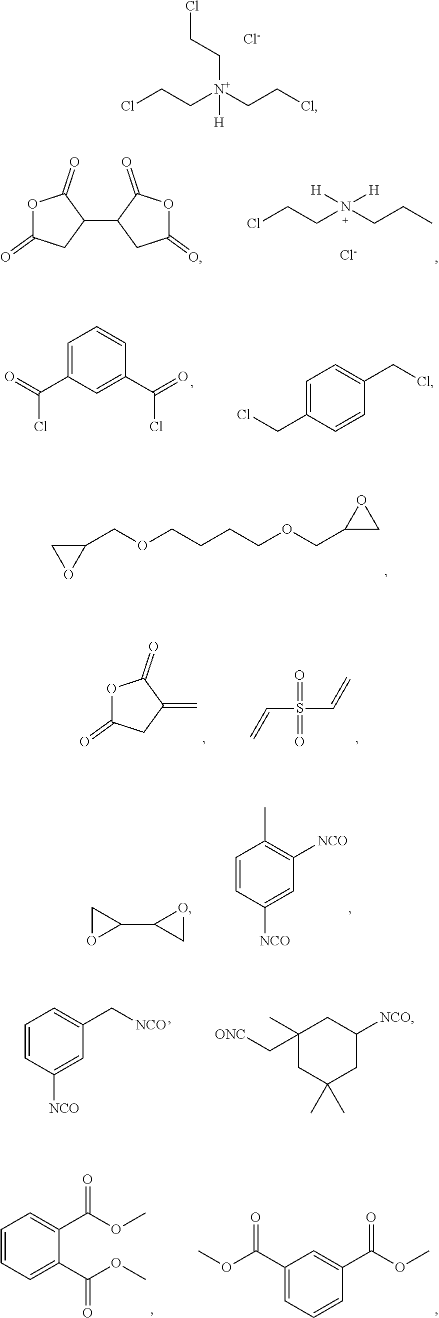

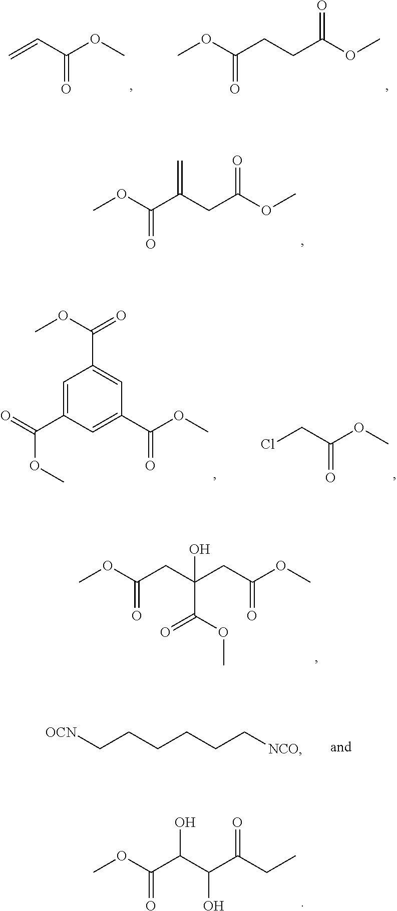

The composition wherein the plurality of cross-linkers are cross-linked to the polyamine polymer backbone chains at a density of 0.01% to 10% (e.g., 0.01% to 7.5%, 0.01% to 5%, 0.01% to 2%, 0.05% to 7.5%, 0.05% to 5%, 0.05% to 2%, or 0.01%, 0.05%, 0.1%, 0.2%, 0.5%, 0.75%, 1%, 2%, 5%, 7.5%, or 10%) by molar ratio of total amines in the plurality of polyamine polymer backbone chains.

The composition wherein the plurality of cross-linkers are cross-linked at a density less than or equal to 1% by molar ratio of total amines in the plurality of polyamine polymer backbone chains.

The composition wherein the one or more chelators each comprise a phenyl group substituted with at least two hydroxyl groups.

The composition wherein the one or more chelators each comprise a phenyl group substituted with at least two hydroxyl groups (e.g., two hydroxyl groups), and the at least two hydroxyl groups include a vicinal diol.

The composition wherein the one or more chelators each comprise 2,3-dihydroxybenzoic acid.

The composition wherein the polymeric chelator particles each comprise at least one group having the structure:

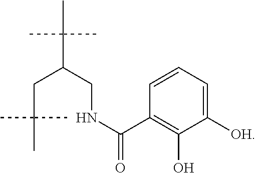

The composition wherein the one or more chelators are each a derivative of a metal chelator moiety.

The composition wherein the one or more chelators each comprise a derivative of deferoxamine, phytic acid, oxalic acid, polyglycerol, polyphenol, benzene-1,2-diol, benzene-1,2,3-triol, 1,10-phenanthroline, or N,N-bis(2-hydroxybenzyl)ethylenediamine-N,N-diacetic acid.

The composition wherein the one or more chelators are capable of chelating a heavy metal.

The composition wherein the one or more chelators are capable of chelating aluminum, arsenic, cadmium, copper, iron, lead, manganese, mercury, or combination thereof. The composition wherein the one or more chelators may selectively bind iron in the presence of aluminum, arsenic, cadmium, chromium, copper, lead, manganese, mercury, or a combination thereof.

The composition wherein the one or more chelators are capable of chelating iron.

The composition wherein the one or more chelators are coupled to 5-30% (e.g., 5-25%, 10-25%, 10-20%, 15-20%, 5%, 10%, 15%, 20%, 25%, or 30%) of the amines on the plurality of polyamine polymer backbone chains.

In an embodiment, the composition may be formulated for injection.

In an embodiment, the composition may be formulated for ingestion.

The composition wherein each of the plurality of polymeric chelator particles is a hydrogel.

Also provided is a method comprising administering to a subject the composition as described above, including any embodiments, alone or in any combination.

Also provided is a method for removing a metal from a medium containing the metal, the method comprising applying the composition as described above, including any embodiments, alone or in any combination, to the medium; incubating the composition in the medium containing the metal to form a polymeric chelator-metal complex; and removing the polymeric chelator-metal complex from the medium. Embodiments of the method for removing a metal from the medium containing the metal include the following, alone or in any combination.

The method for removing a metal from a medium containing the metal wherein the composition is applied to the medium in combination with an antacid.

The method for removing a metal from a medium containing the metal wherein the composition is applied to the medium in combination with an antacid, the antacid being CaCO₃ or NaHCO₃.

Also provided is a method of treating iron overload disease in a subject, the method comprising administering to the subject an effective amount of the composition as described above, including any embodiments, alone or in any combination. As used herein, and as well understood in the art, “to treat” a condition or “treatment” of various diseases and disorders is an approach for obtaining beneficial or desired results, such as clinical results. Beneficial or desired results can include, but are not limited to, alleviation of one or more symptoms or conditions; diminishment of extent of disease, disorder, or condition; stabilizing (i.e., not worsening) state of disease, disorder, or condition; delay or slowing the progress of the disease, disorder, or condition; amelioration or palliation of the disease, disorder, or condition; and remission (whether partial or total), whether detectable or undetectable. “Palliating” a disease, disorder, or condition means that the extent and/or undesirable clinical manifestations of the disease, disorder, or condition are lessened and/or time course of the progression is slowed or lengthened, as compared to the extent or time course in the absence of treatment. The term “effective amount,” as used herein, refers to an amount sufficient to effect beneficial or desired results, such as clinical results, and, as such, a “effective amount” depends upon the context in which it is being applied. The term “subject,” as used herein, can be a human, non-human primate, or other mammal, such as but not limited to dog, cat, horse, cow, pig, goat, monkey, rat, mouse, and sheep. In some embodiments, the subject is a human. Embodiments of the method of treating iron overload disease in a subject include the following, alone or in any combination.

The method of treating iron overload disease in a subject wherein the composition is administered in combination with an antacid, a histamine H2-receptor antagonist, a proton pump inhibitor, or a combination thereof.

The method of treating iron overload disease in a subject wherein the composition is administered in combination with an antacid.

The method of treating iron overload disease in a subject wherein the composition is administered in combination with an antacid, wherein the antacid is CaCO₃ or NaHCO₃.

Also provided is a method of preparing a composition as described above, including any embodiments, alone or in any combination. The method includes (i) providing a polymeric chelator comprising a plurality of polyamine polymer backbone chains and one or more chelators, in which one or more chelators are covalently coupled to one or more primary and/or secondary amines of at least one of the plurality of polyamine polymer backbone chains and the plurality of polyamine polymer backbone chains are cross-linked with a plurality of cross-linkers; (ii) forming crude polymeric chelator particles from the polymeric chelator; and (iii) separating the crude polymeric chelator particles to obtain a plurality of polymeric chelator particles in which at least 90% of the plurality of polymeric chelator particles have a particle size of 300 μm or less. Embodiments include the following alone or in any combination.

The method of preparing a composition as described above, including any embodiments, alone or in any combination, wherein separating the crude polymeric chelator particles comprises micronizing the crude polymeric chelator particles to achieve a distribution range from a first particle size to a second particle size.

The method of preparing a composition as described above, including any embodiments, alone or in any combination, wherein micronizing the crude polymeric particles comprises grinding, crushing, pulverizing, milling, pestling, mashing, pressing, fragmenting, or pounding the crude polymeric chelator particles from the first particle size to the second particle size.

The method of preparing a composition as described above, including any embodiments, alone or in any combination, wherein separating the crude polymeric chelator particles comprises filtering the micronized polymeric particles using a sieve.

The method of preparing a composition as described above, including any embodiments, alone or in any combination, wherein separating the crude polymeric chelator particles comprises filtering the crude polymeric particles using a cyclone. As used herein, a “cyclone” refers to a system that separates particles based on inertial separation. In some embodiments, crude polymeric chelator particles may enter in the cyclone along with one or more inert gases, e.g., nitrogen, argon, helium, or the like, in which larger particles are pushed to a wall of the cyclone and smaller particles flow through the cyclone and are collected.

The method of preparing a composition as described above, including any embodiments, alone or in any combination, wherein said filtering the crude polymeric chelator particles comprises filtering 250 μm polymeric chelators particles from the crude polymeric chelator particles.

The method of preparing a composition as described above, including any embodiments, alone or in any combination, wherein said filtering the crude polymeric chelator particles comprises filtering 150 μm polymeric chelators particles from the crude polymeric chelator particles.

The method of preparing a composition as described above, including any embodiments, alone or in any combination, wherein said filtering the crude polymeric chelator particles comprises filtering 45 μm polymeric chelators particles from the crude polymeric chelator particles.

The method of preparing a composition as described above, including any embodiments, alone or in any combination, wherein said filtering the crude polymeric chelator particles comprises filtering 18 μm polymeric chelators particles from the crude polymeric chelator particles.

### BRIEF DESCRIPTION OF THE DRAWINGS

FIG. 1 depicts the iron binding capacities of sieved samples in pH 2.0 buffer.

FIG. 2 depicts the iron binding capacities of sieved samples in pH 6.0 buffer.

FIG. 3 depicts the particle size analysis of the sample collected on the 150 μm sieve.

FIG. 4 depicts the particle size analysis of the sample collected on the 45 μm sieve FIG. 5 depicts the particle size analysis of the sample that passed through the 45 μm sieve.

### DETAILED DESCRIPTION

Surprisingly, we have found that the ability to chelate metals by polymeric chelators is dependent on the size of the particles. In particular, polymeric chelators having a particle size of 150 μm or less, have been found to absorb metals such as iron more effectively than larger particles having identical chemical compositions and bulk polymeric chelator hydrogels having the identical compositions, such as those described in U.S. Pat. Nos. 9,402,861, 9,974,863, and 10,039,836, the contents of which are incorporated herein by reference their entirety.

The present disclosure includes new compositions for chelation of metals. In some embodiments, the present disclosure provides a composition comprising a plurality of polymeric chelator particles in which at least 90% of the particles have a particle size of 300 μm or less, such as 300 μm to 2 μm, 200 μm to 4 μm, 150 μm to 4 μm, 100 μm to 5 μm or 70 μm to 18 μm, 45 μm to 18 μm, or 45 μm or less, such as a particle size of 300 μm, 275 μm, 250 μm, 225 μm, 200 μm, 175 μm, 150 μm, 125 μm, 100 μm, 75 μm, 65 μm, 55 μm, 50 μm, 45 μm, 40 μm, 35 μm, 30 μm, 25 μm, 20 μm, 18 μm, 15 μm, 12.5 μm, 10 μm, 7.5 μm, 5 μm, 4 μm, 3 μm, 2 μm, or 1 μm. In some embodiments, the size of the polymeric chelator particles is determined using laser diffraction, for example by using a Malvern Masterizer. In embodiments, the size of the polymeric chelator particles measured by laser diffraction comprises a d10 of 100 μm or less, such as a d10 of 100 μm, 75 μm, 65 μm, 55 μm, 50 μm, 45 μm, 40 μm, 35 μm, 30 μm, 25 μm, 20 μm, 18 μm, 15 μm, 12.5 μm, 10 μm, 7.5 μm, 5 μm, 4 μm, 3 μm, 2 μm, or 1 μm. In embodiments, the size of the polymeric chelator particles measured by laser diffraction comprises a d50 of 150 μm or less, such as a d50 of 150 μm, 125 μm, 100 μm, 75 μm, 65 μm, 55 μm, 50 μm, 45 μm, 40 μm, 35 μm, 30 μm, 25 μm, 20 μm, 18 μm, 15 μm, 12.5 μm, 10 μm, 7.5 μm, 5 μm, 4 μm, 3 μm, 2 μm, or 1 μm. In embodiments, the size of the polymeric chelator particles measured by laser diffraction comprises a d90 of 250 μm or less, such as a d90 of 250 μm, 225 μm, 200 μm, 175 μm, 150 μm, 125 μm, 100 μm, 75 μm, 65 μm, 55 μm, 50 μm, 45 μm, 40 μm, 35 μm, 30 μm, 25 μm, 20 μm, 18 μm, 15 μm, 12.5 μm, 10 μm, 7.5 μm, 5 μm, 4 μm, 3 μm, 2 μm, or 1 μm.

Generally, the present disclosure includes compositions and systems for chelation of metals. In some embodiments, the present disclosure provides a composition comprising a plurality of polymeric chelator particles. Each of the polymeric chelator particles can include a plurality of polymer backbone chains coupled with one or more metal chelators. The system can include a plurality of polymer backbone chains and one or more metal chelators that are coupled together or otherwise linked so as to combine the properties of the polymer and the ability to chelate a metal.

In some embodiments, the polymer backbone chain that is coupled with the metal chelator may include any polyamine polymer such as polyallylamine (PAAm), poly(N-vinyl) formamide (PNVF), polyvinylamine (PVAm), poly(L-lysine) (PLL), polyethylenimine (PEI), or the like. The polymer may also include amino acids, and the polymer can include polypeptides and proteins.

In some embodiments, any polymer may be used that is capable of being coupled to a chelator, such as an iron chelator, which can be used for chelation so as to combine the properties of the polymer with the ability to chelate. The polymers can be any type of polymer that is linear, branched, cross-linked, hydrogel, or the like or a soluble polymer, a non-soluble polymer, a cross-linked polymer, an un-cross-linked polymer, or the like. The polymers can include polyamines that have amine functional groups capable of participating in reactions with chelators. In some examples the polymer may comprise polyamine polymers such as PVAm and PAAm. PVAm and PAAm are polycation hydrogels consisting of reactive primary amine side groups for the conjugation of the chelator. In some embodiments, the cross-linked PVAm hydrogel may be synthesized by hydrolyzing a precursor polymer, PNVF, in a basic medium. In some embodiments, cross-linked PAAm hydrogel may be synthesized by cross-linking the precursor PAAm chains. Both hydrogels may demonstrate a high affinity and selectivity for iron at pHs similar to those found in the GI tract.

In some embodiments, the chelator coupled to the polymer may include 2,3-dihydrobenzoic acid (DHBA) and/or other iron chelators. 2,3-DHBA acid is a fragment of the well-known natural iron chelator Enterobactin (Log K=52) which is a high affinity siderophore that acquires iron for microbial systems. Chelators of other metals that can be coupled to a polymer may also be included.

In some embodiments, the chelator may be coupled to the polymer via a carboxyl group of the chelator. In some embodiments, the chelator may be coupled to the polymer via a peptide bond. In some embodiments, the chelators can include a feature for coupling with the polymer, such as carboxy groups (including activated carboxy groups, e.g., N-hydroxysuccinimide (NHS)-activated carboxy groups, or activated carboxylate groups) that can be coupled to the amines of the polymer through amide bonds. Other examples of features that can be included in the chelators for coupling with the polymer include, but are not limited to, epoxide, vinyl amide, vinyl sulfonamide, anhydride, aldehyde, isocyanate, isothiocyanate, haloalkyl (e.g., chloroalkyl or bromoalkyl), haloaryl (e.g., fluorophenyl or chlorophenyl), carbonate, N-hydroxysuccinimide ester, imidoester, haloaryl ester (e.g., fluorophenyl ester), 4-nitrophenyl ester, carbodiimide, sulfonyl chloride, acyl azide, alkyl ester, vinyl acyl, succinic anhydride, and chloroacyl. In some embodiments, the feature may be any one of the following groups:

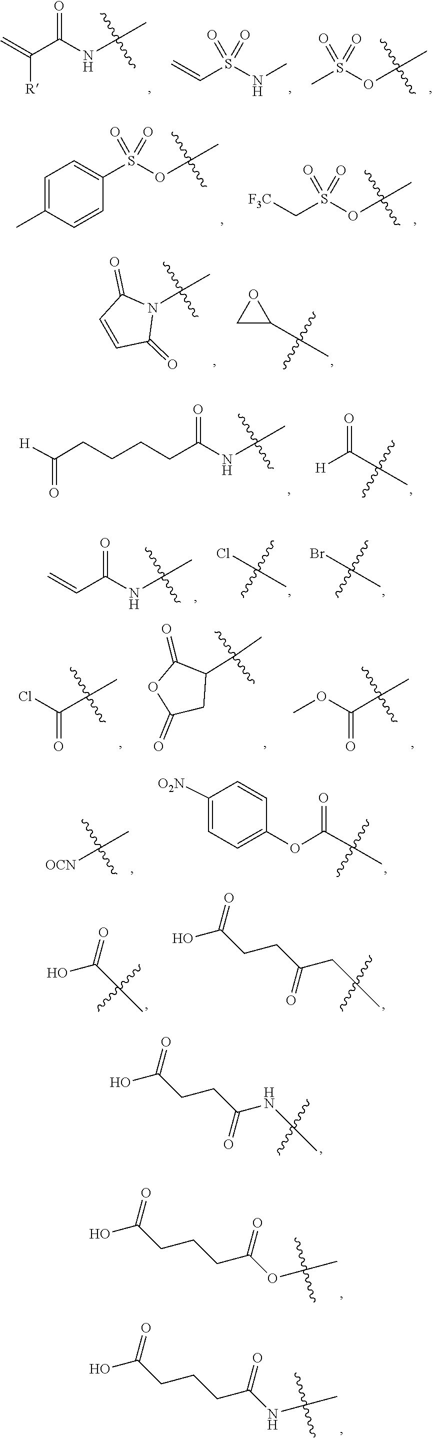

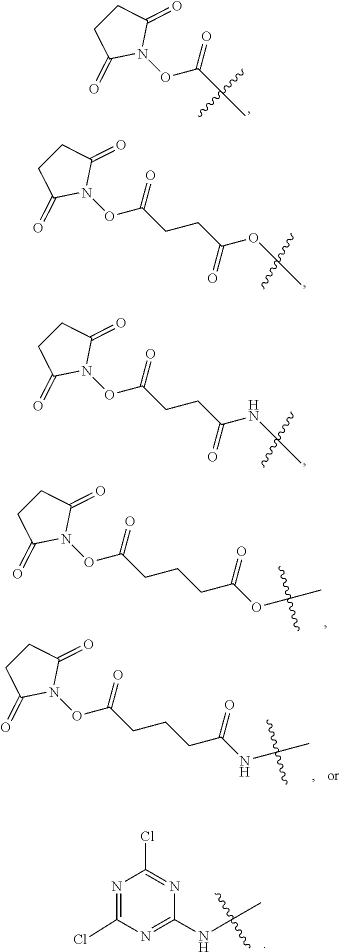 [SMILES: *C(=O)ON1C(=O)CCC1=O ; *OC(=O)CCC(=O)ON1C(=O)CCC1=O ; *NC(=O)CCC(=O)ON1C(=O)CCC1=O ; *OC(=O)CCCC(=O)ON1C(=O)CCC1=O ; *NC(=O)CCCC(=O)ON1C(=O)CCC1=O ; *Nc1nc(Cl)nc(CCl)n1]

Other cross-linking or coupling reagents can be included in the polymer and chelator system in order to prepare a polymeric chelator having the ability to chelate iron. Examples of iron chelating small molecules are referenced in U.S. Pat. No. 3,758,540. Examples of chelator schemes may be found in U.S. Pat. Nos. 7,342,083, 5,702,696, and 5,487,888.

Those of skill in the art will appreciate other chelators. By way of example but not limitation, additional chelators to be tested may include commercially available chelators such as Desferal® (deferoxamine mesylate) and/or may contain moieties such as phenolates, enolic hydroxyls, ketones, aldehydes, carboxylates, phosphates and phosphonates, thiolates, sulfides and disulfides, hydroxamic acids and hydroxamates, amines, amides, and nitrones. In some embodiments, the chelator may be a derivative of deferoxamine, phytic acid, oxalic acid, polyglycerol, polyphenol, benzene-1,2-diol, benzene-1,2,3-triol, 1,10-phenanthroline, or N,N-bis(2-hydroxybenzyl)ethylenediamine-N,N-diacetic acid, e.g., a derivative of the aforementioned groups that is derivatized to include any one of the features for coupling with the polymer described above.

In some embodiments, the plurality of polymeric chelator particles are made by reacting 2,3-dihydroxybenzoic acid (DHBA), a known iron chelator, to a plurality of polyamine polymer backbone chains.

In some embodiments, the composition can be fabricated as solids or equilibrated in aqueous solution as a solution or suspension. The polyamine conjugates have exceptional binding affinity and selectivity for iron. In some examples the polyamine polymer may comprise PVAm and PAAm. PVAm and PAAm are polycation hydrogels consisting of reactive primary amine side groups for the conjugation of 2,3-DHBA. 2,3-DHBA acid is a fraction of the well-known natural iron chelator Enterobactin (Log K=52) which is a high affinity siderophore that acquires iron for microbial systems. Cross-linked PVAm hydrogel may be synthesized by hydrolyzing a precursor polymer, PNVF, in a basic medium. Cross-linked PAAm hydrogel mat be synthesized by cross-linking the precursor PAAm chains. Both types of polymeric chelator hydrogels may demonstrate a high affinity and selectivity for iron at pHs similar to the GI tract.

Notably, the polyamine backbone chains can be crosslinked, wherein the cross-linker comprises N,N′-methylenebisacrylamide.

In some embodiments, conjugation of 2,3-dihydroxybenzoic acid may facilitate the iron binding affinity and iron selectivity of the final hydrogel conjugates, the polymeric chelator. In some embodiments, the primary amine groups in both polymers may be used as a conjugation site. The non-degradable PVAm and PAAm hydrogels conjugated to 2,3-DHBA can be used as oral therapeutics in iron overload disease patients. This therapeutic agent can selectively bind iron and remove it from the GI tract before it is being absorbed into the blood stream.

In other embodiments, thioglycolic acids (TGA) in combination with the siderophore moiety dihydroxybenzoic acid (DHBA) may be introduced onto PAAm and PVAm to form the polymeric chelator.

In some embodiments, the plurality of cross-linkers each comprise polyethylene glycol. “Polyethylene glycol” or “PEG,” as used herein, refers to a group of the general formula —(OCH₂CH₂)ₙO—, in which n is an integer (e.g., 2-150, 2, 3, 4, 5, 5-10, 10-20, 20-30, 30-40, 50-60, 60-70, 70-80, 80-90, 90-100, 100-110, 110-120, 120-130, 130-140, or 140-150). In some embodiments, the PEG has a molecular weight (number average molecular weight; “Mn”) of 200 Da to 6000 Da (e.g., 400 Da to 2500 Da, 800 Da to 2200 Da, 1000 Da to 2000 Da, 200 Da, 400 Da, 600 Da, 800 Da, 1000 Da, 1200 Da, 1500 Da, 2000 Da, 2200 Da, 2500 Da, 3000 Da, 3500 Da, 4000 Da, 4500 Da, 5000 Da, 5500 Da, or 6000 Da). PEG-based crosslinkers are generally known in the art and are commercially available.

PEG-based crosslinkers for amine PEGylation include reactive end groups include, but are not limited to carboxy, epoxide, vinyl amide, vinyl sulfonamide, anhydride, aldehyde, isocyanate, isothiocyanate, haloalkyl (e.g., chloroalkyl or bromoalkyl), haloaryl (e.g., fluorophenyl or chlorophenyl), carbonate, N-hydroxysuccinimide ester, imidoester, haloaryl ester (e.g., fluorophenyl ester), 4-nitrophenyl ester, carbodiimide, sulfonyl chloride, acyl azide, alkyl ester, vinyl acyl, succinic anhydride, and chloroacyl. In embodiments, the plurality of cross-linkers are derived from polyethylene glycol diacrylate units.

In some embodiments, a PEG-based crosslinker comprises two or more PEG chains connected via one or more linkers. Molecules that may be used as linkers include at least two functional groups (which may be the same or different) that can form covalent linkages with the reactive end groups of individual PEG chains. The functional groups include, but are not limited to, amine, carboxy, epoxide, vinyl amide, vinyl sulfonamide, anhydride, aldehyde, isocyanate, isothiocyanate, haloalkyl (e.g., chloroalkyl or bromoalkyl), haloaryl (e.g., fluorophenyl or chlorophenyl), carbonate, N-hydroxysuccinimide ester, imidoester, haloaryl ester (e.g., fluorophenyl ester), 4-nitrophenyl ester, carbodiimide, sulfonyl chloride, acyl azide, alkyl ester, vinyl, vinyl acyl, succinic anhydride, and chloroacyl. In some embodiments, the individual PEG chains each include two different reactive end groups, e.g., one for forming a conjugate linkage with the linker, and one for forming a conjugate linkage with an amine on a polyamine polymer backbone chain. Strategies for forming linkages between individual PEG chains are generally known in the art.

In some embodiments, the plurality of cross-linkers comprise individual hydrophilic cross-linkers. In some embodiments, the hydrophilic cross-linker is a compound having a water solubility greater than that of N,N′-methylene bisacrylamide at 20° C. In some embodiments, the hydrophilic cross-linker is a compound having a water solubility of greater than 20 g/L (e.g., at least 50 g/L, at least 100 g/L, at least 150 g/L, at least 200 g/L, at least 250 g/L, at least 300 g/L, at least 500 g/L, at least 550 g/L, at least 600 g/L, or at least 650 g/L) at 20° C.

In some embodiments, the plurality of cross-linkers comprise individual cross-linkers preferably having a molecular weight of 400 Daltons to 2500 Daltons, 400 to 1200 Daltons, or 400 to 1000 Daltons, more preferably having a molecular weight of 800 Daltons to 2200 Daltons or 800 Daltons to 2000 Daltons.

In some embodiments, the plurality of cross-linkers are cross-linked to the polyamine polymer backbone chains at a density of 0.01% to 10% (e.g., 0.01% to 7.5%, 0.01% to 5%, 0.01% to 2%, 0.05% to 7.5%, 0.05% to 5%, 0.05% to 2%, or 0.01%, 0.05%, 0.1%, 0.2%, 0.5%, 0.75%, 1%, 2%, 5%, 7.5%, or 10%) by molar ratio of total amines, preferably at a density less than or equal to 1% by molar ratio of total amines, such as 0.05% to 1% by molar ratio of total amines.

In some embodiments, the cross-linkers each have a molecular weight of 400 Daltons to 1200 Daltons and a cross-linking density of 0.01% to 2% by molar ratio of total amines; cross-linked polymers wherein the crosslinkers have a molecular weight of 400 Daltons to 1200 Daltons and a cross-linking density of 0.01% to 5% by molar ratio of total amines; cross-linked polymers wherein the crosslinkers have a molecular weight of 800 Daltons to 2200 Daltons and a cross-linking density of 0.01% to 2% by molar ratio of total amines; cross-linked polymers wherein the crosslinkers have a molecular weight of 800 Daltons to 2200 Daltons and a cross-linking density of 0.01% to 5% by molar ratio of total amines.

In one embodiment, the present disclosure provides a composition comprising a monomer having the DHBA coupled thereto. The monomer can be coupled to the DHBA by the monomer having an amine group which reacts and couples with the carboxyl group of the DHBA. The monomer having the DHBA can be used in composition similarly to that which is described in connection with the polymer coupled to DHBA. Examples of suitable monomers include any monomer that is capable of being coupled to a chelator, such as an iron chelator. The monomer can be any type of monomer. The monomer can include amines that have amine functional groups capable of participating in reactions with chelators. In some examples the monomer may comprise amine monomers.

In one embodiment, a polymeric chelator can be made by reacting 2,3-DHBA to a polyamine polymer through the formation of an amide bond. The polyamine-DHBA chelating polymer has exceptional binding affinity and selectivity for iron.

Briefly, conjugation of DHBA to PVAm and PAAm can be achieved through formation of amide bonds. Both PVAm and PAAm are polycation hydrogels that have reactive primary amine side groups that can be coupled to 2,3-DHBA. Cross-linked PVAm hydrogel can be synthesized by hydrolyzing a precursor polymer, PNVF, in a basic medium. Cross-linked PAAm hydrogel can be synthesized by cross-linking the precursor PAAm chains.

In some embodiments, synthesized cross-linked polymers may be washed according to a washing procedure. The washing procedure may include administering one or more washing solutions. In some embodiments, a washing solution has one or more bases. The one or more bases may be capable of quenching the synthetic reaction. In some embodiments, the one or more bases may include sodium hydroxide, potassium hydroxide, calcium hydroxide, or the like. In some embodiments, the washing solution may have a concentration of 0.01-1.0 M base in an aqueous solution (e.g., 0.01 M, 0.05 M, 0.1 M, 0.15 M, 0.2 M, 0.25 M, 0.3 M, 0.35 M, 0.4 M, 0.45 M, 0.5 M, 0.55 M, 0.6 M, 0.65 M, 0.7 M, 0.75 M, 0.8 M, 0.85 M, 0.9 M, 0.95 M, or 0.1 M). Alternatively, in some embodiments the washing solution may be deionized water.

In some embodiments, the washing procedure may include washing the synthesized cross-linked polymers with a first washing solution having a base, and subsequently washed with a second washing solution of deionized water. In some embodiments, the first washing solution or second washing solution may be administered under the protection of an inert gas, e.g., nitrogen, argon, helium, or the like. For example, the first washing solution or second washing solution may be administered under the protection of nitrogen gas.

The composition can be fabricated as solids, gels, pastes, liquids, such as being equilibrated in aqueous solution as a solution or suspension.

In some embodiments, the polyamine polymer backbone chains can be crosslinked through the chelated metal. This can occur with separate chelation moieties of two or more polymers chelating the same metal.

In some embodiments, the composition can be administered orally to treat, inhibit, or prevent iron overload. As such, the composition can be included in oral therapeutics for use in iron overload disease patients. The composition can selectively bind iron and remove it from the GI tract before it is being absorbed into the blood stream. The composition can be deposited in tissues or administered systemically for iron chelation.

The composition may be used as metal chelators to remove metals from a wide range of substance and can have applications in a wide range of diverse fields. Polycations have been employed in industrial applications such as water treatment and ion exchange resins (for separation-purification purposes). The high affinity and selectivity for iron provides important features for the application of these compositions.

The composition can be highly effective metal (e.g., iron) chelators that selectively bind metals in the GI tract and prevent the metal from being absorbed into the blood stream. The chelated metal can be passed from the GI tract as waste.

In some embodiments, the present disclosure provides a composition (e.g., any one of the compositions disclosed herein) may be injected or ingested. In some embodiments, dosage form design may aid patient compliance. The gel format may retain chelators in the gastrointestinal tract to enable self-dosing of the compound as necessary and to mitigate systemic side effects that plague current iron chelators. The injectable composition may improve safety compared to DFO and the polymer molecular weight may be optimized to extend circulation half-life.

In one embodiment, the polymeric chelator can be configured to include a polymer or monomer that is soluble in water. The composition can be configured to be injected and to be relatively non-toxic or have reduced toxicity. In one embodiment, the polymeric chelator can be configured to have an appropriate molecular weight for injection. In another embodiment, the polymeric chelator can be configured to have an appropriate molecular weight for ingestion. Also, the composition having a polymeric chelator can be configured for inhalation or for topical application.

In one embodiment, a polymeric chelator can be ingested and can block metal absorption by chelating the metal. The composition can include a cross-linked polymer configured for ingestion. Some embodiments, the composition can be ingested and be configured to be absorbed from the intestine such that the chelator can chelate metals that have already been absorbed into the body.

In some embodiments, the polymeric chelator particles disclosed herein may more accurately mimic the Enterobactin side chain shown. Polymeric chelator particles that mimic the structure of siderophore may be considered as a desirable parenterally administered iron chelator. The plasma half-life of these polymeric agents can be optimized based on the initial molecular weight of the polymer. Moreover, the toxic side effect of these polymeric chelator particles may be significantly reduced because they consist of polypeptide units. Polymeric forms of siderophore mimetics offer several therapeutic advantages. These compounds can disable bacterial recruitment of iron. Also, polymeric chelator particles can localize the compounds to the GI tract (oral gel material) and/or extend the circulation half-life by increasing molecular weight (injected material).

In certain embodiments, the polymeric chelator particles will not be absorbed when orally given. These materials may demonstrate rapid iron binding with high affinity and selectivity. In some embodiments, the pM values for iron binding of the materials disclosed herein are at least ten times higher than any of the existing therapeutic chelators. The design of these polymers can mitigate the systemic side effects and toxicity of current drugs. In some embodiments, the polymeric chelator particles selectively and effectively bind iron in the GI tract if administered orally or from the bloodstream if administered parenterally.

In one embodiment, the polymeric chelator particles can be incorporated into textiles, fabrics, absorbent members, gauze, wipes, bandages, or the like. Further applications of the polymeric chelators can be used for metal chelation in a wide range of consumer products and processes. An example of one process that the polymeric chelator particles can be useful is in oil well treatments, such as those treatments for descaling or inhibiting the formation of scales.

To facilitate a better understanding of the present invention, the following examples of specific embodiments are given. In no way should the following examples be read to limit or define the entire scope of the invention.

### EXAMPLES

Preparation of a 2,3-dihydroxybenzoic acid-modified cross-linked poly(allylamine) chelators used in the sieving studies is described below.

### Materials.

Poly(allylamine hydrochloride) (PAAm) with an average molecular weight of 15 kDa and analytical grade reagent N,N′-methylenebisacrylamide (MBA) were obtained from Sigma-Aldrich and used without further modification. 2,3-DHBA, N,N,N-triethylamine, dimethylformamide (DMF), potassium phosphate and all metal chlorides were purchased from Fisher Scientific and used as received. N-(3-Dimethylaminopropyl)-N′-ethylcarbodiimide hydrochloride (EDC) and N-hydroxysuccinimide (NHS) were purchased from Thermo Scientific and used without further modification. Deionized water (DI) was obtained from a Barnstead EasyPure water purifier.

### NHS-activated 2,3-DHBA

A solution of 2,3-DHBA (770 mg, 5 mmol) and NHS (690 mg, 6 mmol) in 5 mL of DMF was mixed with a solution of EDC (1200 mg, 6.2 mmol) in 5 mL of DMF. The mixture was stirred at room temperature for 8 h and used for the next reaction step without any purification.

### Preparation of 2,3-Dihydroxybenzoic Acid Modification of Hydrogel.

The PAAm cross-linking and 2,3-DHBA conjugation were conducted in a single-step reaction. Briefly, a 15% w/w PAAm (15 kDa) solution containing a predetermined amount of BMA (1% molar ratio of total amines) was prepared in H₂O/DMF (50/50 v/v) mixture. Then, the NHS-activated 2,3-DHBA solution was added to the reaction mixture, with a final DHBA/amine molar ratio of 25% and was sonicated until a transparent solution was achieved (˜2 minutes). Triethylamine (TEA) was then added to the solution and mixed thoroughly, and the solution was incubated at room temperature for 48 h. The resultant cross-linked polymers were then washed with 0.1 M sodium hydroxide and subsequently washed with deionized water for several days under the protection of nitrogen.

The 2,3-DHBA modified PAAm hydrogel was lyophilized and ground to fine powder by a mortar and pestle set for 5 min.

### Example 1

### Sample Sieving and Size Distribution.

2.36 g of the ground fine powder sample was placed on the top sieve (1.18 mm) of a Gilson Performer SS-3 Performer III Sieve Shaker. The amplitude was set to 7, and the sieving was carried out for 30 min. The sample on each sieve was collected and weighed, as reported in Table 1.

TABLE 1

| Sieve | Mass (mg) |
|---|---|
| 1.18 mm | 439.8 |
| 600 μm | 733.2 |
| 425 μm | 252.3 |
| 250 μm | 303.1 |
| 150 μm | 229.3 |
| 45 μm | 294.1 |
| Collector (<45 μm) | ~2 |

### Example 2

### Grinding Large Size Samples and Sieving.

The samples collected by sieve 1.18 mm, 600 μm, and 425 μm in Example 1 were combined and ground by a mortar and pestle set for 5 min. Then the ground sample was placed on the top sieve (1.18 mm) of a Gilson Performer SS-3 Performer III Sieve Shaker. The amplitude was set to 7, and the sieving was carried out for 30 min. The sample on each sieve was collected and weighed, as reported in Table 2.

TABLE 2

| Sieve | Mass (mg) |
|---|---|
| 1.18 mm | 0 |
| 600 μm | 0 |
| 425 μm | 0 |
| 250 μm | 70.46 |
| 150 μm | 303.46 |
| 45 μm | 672.82 |
| Collector (<45 μm) | 229.1 |

### Example 3

### Further Grinding Small Size Samples and Sieving.

The samples collected by sieve 250 μm, 150 μm, and 45 μm in Example 2 were combined and ground by a mortar and pestle set for 5 min. The bottoms of the 1.18 mm sieve and 600 μm sieve were covered by a 18 μm and a 10 μm nylon mesh filter, respectively.

Then the ground sample was placed on the 250 μm sieve. The sample collected by the collector (<45 μm) was placed on the 1.18 mm sieve (with a 18 μm nylon mesh filter on the bottom). The order of the sieve was shown in the table. The amplitude was set to 7, and the sieving was carried out for 30 min. The sample on each sieve was collected and weighed, as reported in Table 3.

TABLE 3

| Sieve | Mass (mg) |
|---|---|
| 425 μm | 0 |
| 250 μm | 0 |
| 150 μm | 20.35 |
| 45 μm | 825.24 |
| 18 μm (1.18 mm sieve) | 385.33 |
| 10 μm (600 μm sieve) | <2 |
| Collector (<10 μm) | 0 |

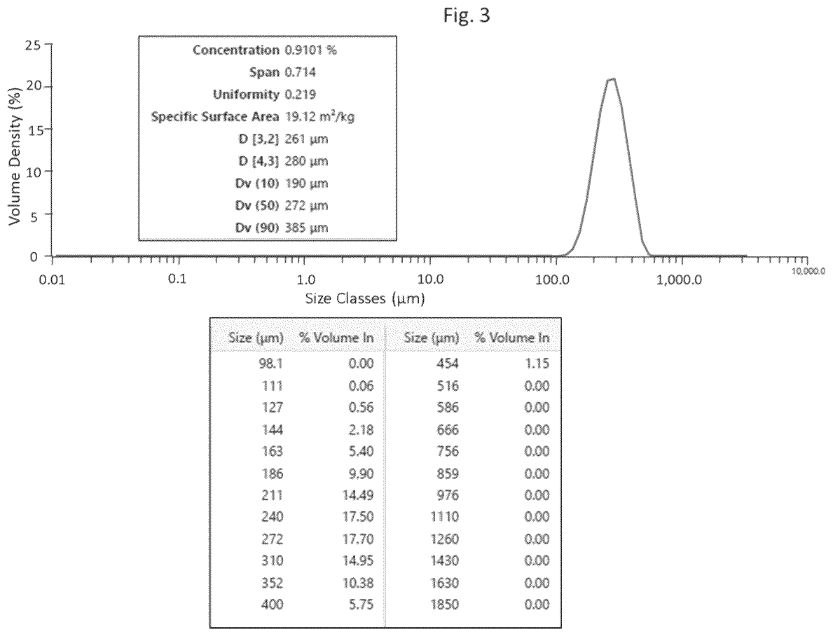

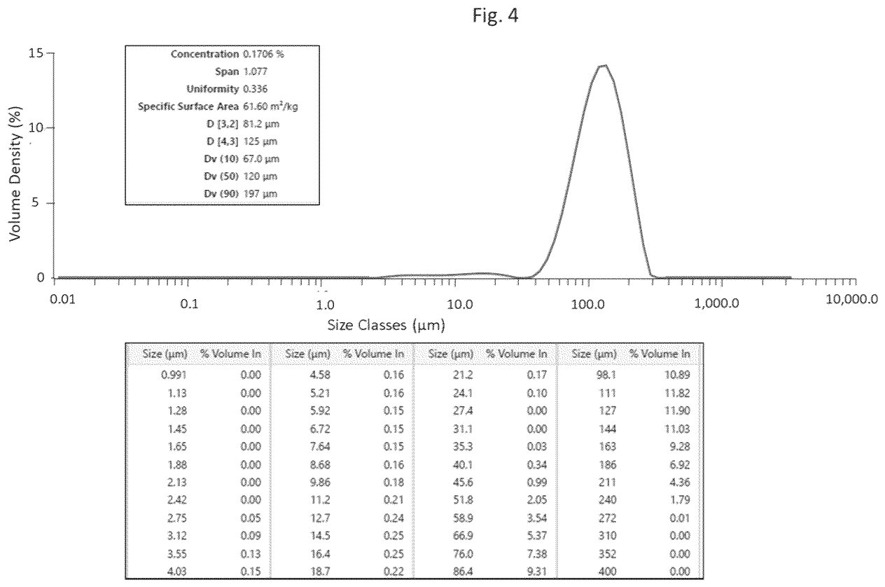

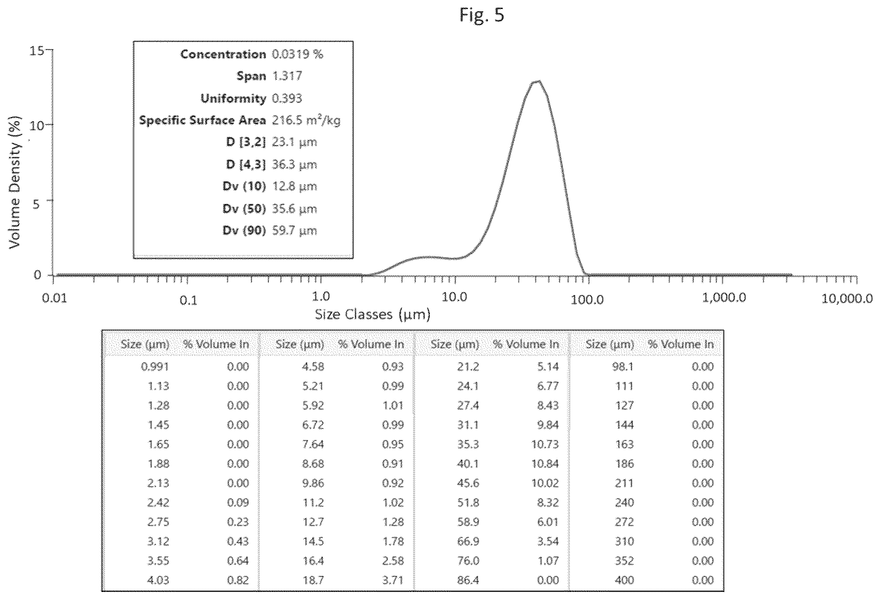

Particle size analysis was performed on the samples collected by the 150 μm sieve, the 45 μm sieve, and the sieves that collected particles smaller than 45 μm.1 mg of samples was suspended in water and the size of the particles were analyzed by Malvern MASTERSIZER 3000. The results are depicted in FIG. 3 (150 μm), FIG. 4 (45 μm), and FIG. 5 (<45 μm), indicating the size ranges of particles detected in the samples.

### Example 4

### Iron Binding Capacity of Ground and Sieved Samples.

The iron binding capacities of samples collected in Examples 1-3 were analyzed.

Methods. For a typical iron binding assay, 4 mL of 10 mM FeCl₃ stock solution was first added into 16 mL pH 6.0 buffer in a 50 mL Falcon tube. Then a weighed iron binding polymer sample (around 20 mg) was added into the solution and vortexed for 10 sec. Each sample needs 3 replicates. Three control solutions (without iron binding polymers) were prepared by adding 4 mL of 10 mM FeCl₃ stock solution into 16 mL pH 6.0 buffer. All these solutions (in 50 mL Falcon tubes with caps) were incubated in a shaker (preheated at 37° C.) with a shaking speed of 100 rpm at 37° C. for 24 h. Then these solutions were passed through 0.22 μm filters and stored at room temperature. The iron concentrations were tested by ICP-OES.

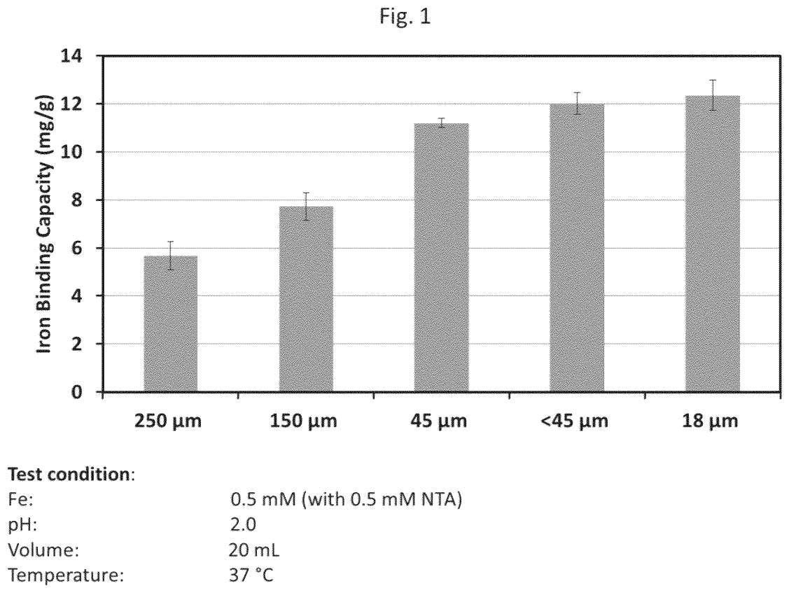

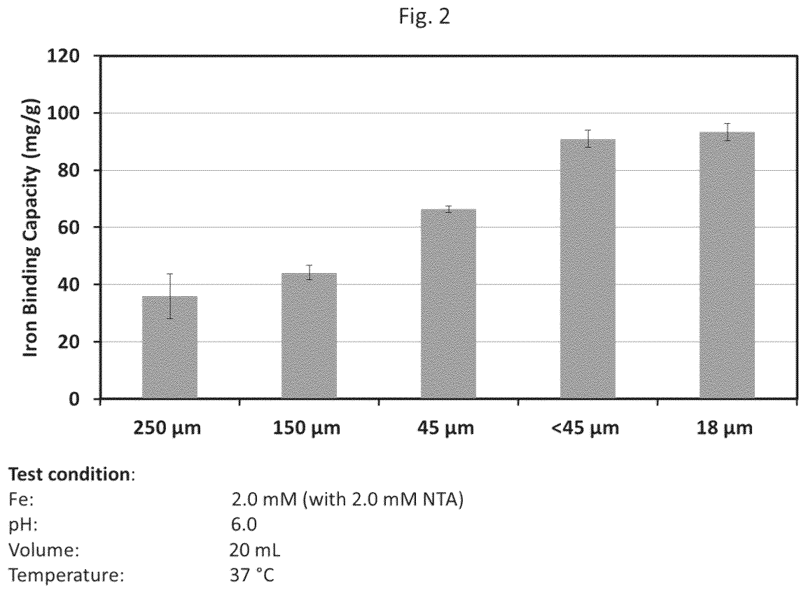

Results. FIG. 1 and FIG. 2 depict the iron binding capacities at pH 2 and pH 6, respectively, of the particles sieved in Example 3. As shown in FIGS. 1 and 2, the iron binding capacity of samples unexpectedly increased as the particle size decreased at both pH 2.0 and pH 6.0.

### Example 5: Alternate Preparation of a 2,3-Dihydroxybenzoic Acid-Modified Cross-Linked Poly(Allylamine) Chelators Used in the Sieving Studies is Described Below

### NHS-activated DHBA.

A solution of DHBA (0.5 kg, 3.27 mol), NHS (0.75 kg, 6.54 mol) in 1.7 L of DMF was mixed with a suspension of EDC (0.56 kg, 2.9 mmol) in 1.7 L of DMF. The mixture was stirred until completion of the reaction and used for the next reaction step.

Preparation of DHBA Modification of Hydrogel. PAAm with an average molecular weight of 15 kDa-18 kDa (2.5 kg of a 50% solution in water, 13.1 mol) is further diluted with 1.98 kg of water before the NHS-activated DHBA solution is added, followed by an additional 0.125 kg of water, followed by a solution of BMA (0.002 kg, 0.01 mol) in DMF/water (0.25 L each) and triethylamine (2.35 kg, 23.2 mol). The reaction mixture is stirred for 24 hours. The resultant cross-linked polymers were then washed with 0.1 M sodium hydroxide, acetonitril/water, iso-propanol and isopropanol/water. The resulting polymer was than milled and sieved to archive the target particle size distribution.

### Example 6

### Sample Filtering Using a Cyclone.

Crude polymeric chelator particles may enter a cyclone, e.g., a cylindrical body having a conical outlet for solids and a top axial pipe outlet for gas) along with one or more inert gases, e.g., nitrogen, argon, helium, or the like. The gas may flow such that a vortex flowing down towards the conical outlet will be created. Crude polymeric chelator particles having a large diameter, e.g., greater than 300 μm, will be pushed against a wall of the cyclone such that the particles are separated from the gas flow. The large diameter particles may travel down the wall according to gravity, in which the particles are collected at the bottom of the conical outlet. Alternatively, crude polymeric chelator particles having a diameter of 2 μm to 300 μm may travel along the gas flow such that the particles exit at the top axial pipe outlet along with the gas.

In one embodiment, the cyclone may filter 250 μm polymeric chelators particles from the crude polymeric chelator particles. In another embodiment, the cyclone may filter 150 μm polymeric chelators particles from the crude polymeric chelator particles. In one embodiment, the cyclone may filter 45 μm polymeric chelators particles from the crude polymeric chelator particles. In one embodiment, the cyclone may filter 18 μm polymeric chelators particles from the crude polymeric chelator particles.

What is claimed is:

1-45. (canceled)

46. A composition comprising:
a plurality of polymeric chelator particles each comprising a plurality of polyamine polymer backbone chains and one or more chelators,
wherein at least 90% of the plurality of polymeric chelator particles have a particle size of 300 μm or less,
wherein the one or more chelators are covalently coupled to one or more primary and/or secondary amines of at least one of the plurality of polyamine polymer backbone chains; and
wherein the plurality of polyamine polymer backbone chains are cross-linked with a plurality of cross-linkers.

47. The composition of claim 46, wherein at least 90% of the plurality of polymeric chelator particles have a particle size of 2 μm to 300 μm.

48. The composition of claim 46, wherein at least 90% of the plurality of polymeric chelator particles have a particle size of 4 μm to 200 μm.

49. The composition of claim 46, wherein at least 90% of the plurality of polymeric chelator particles have a particle size of 4 μm to 150 μm.

50. The composition of claim 46, wherein at least 90% of the plurality of polymeric chelator particles have a particle size of 5 μm to 100 μm.

51. The composition of claim 46, wherein at least 90% of the plurality of polymeric chelator particles have a particle size of 18 μm to 70 μm.

52. The composition of claim 46, wherein each of the plurality of polyamine polymer backbone chains comprises a polyamine polymer having a weight average molecular weight of 1-50 kDa.

53. The composition of claim 46, wherein each of the polyamine polymer backbone chains comprising repeating monomeric units each having the structure: 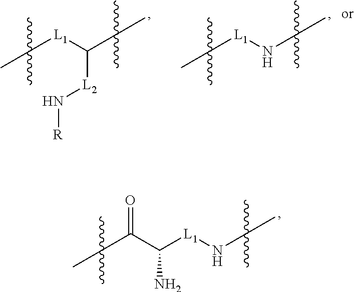
wherein
L₁ is C₁-C₆alkylene;
L₂ is a bond or C₁-C₆alkylene; and
R is H or C(O) R″, in which R″ is H, C₁-C₆ alkyl, or C₆-C₁₂ aryl.

54. The composition of claim 53, wherein the plurality of polyamine polymer backbone chains each comprise polyallylamine.

55. The composition of claim 53, wherein the plurality of polyamine polymer backbone chains each comprise poly(L-lysine).

56. The composition of claim 46, wherein each of the plurality of cross-linkers is independently of structure: 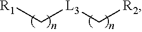
wherein
R₁ and R₂ are independently selected from: 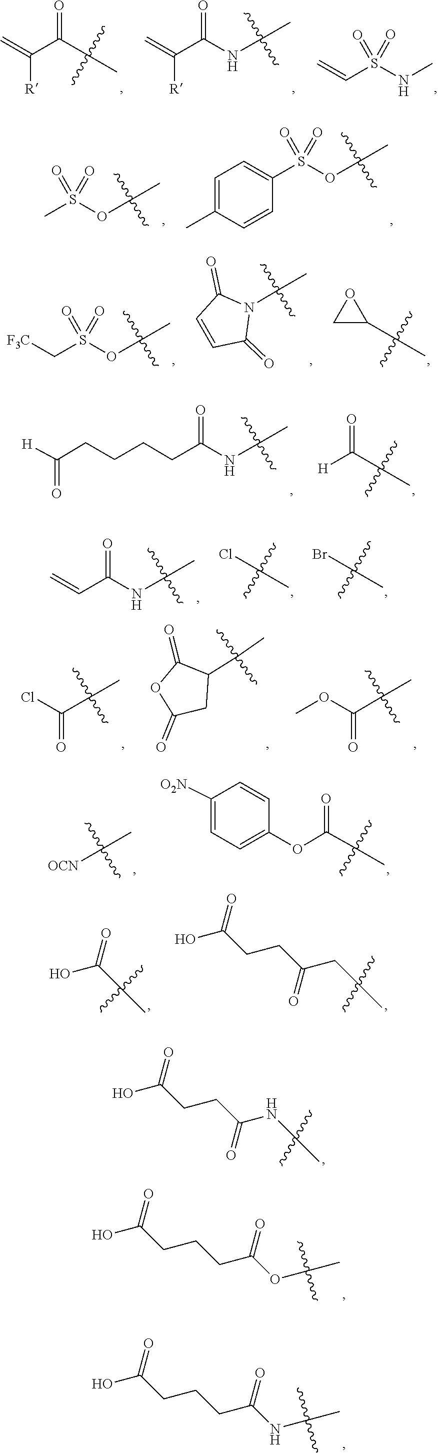 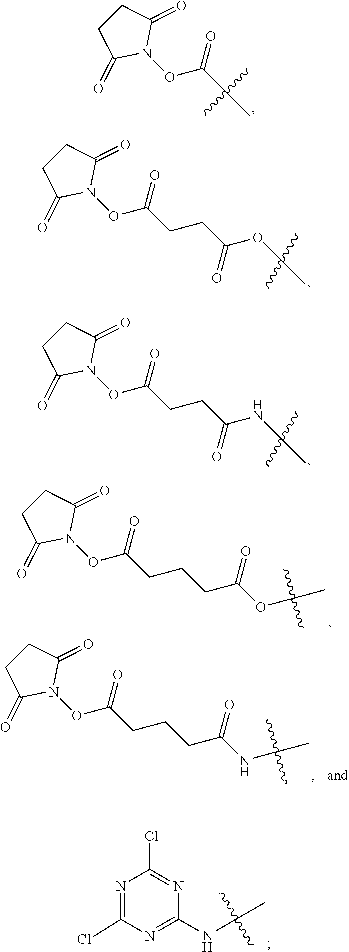 [SMILES: *C(=O)ON1C(=O)CCC1=O ; *OC(=O)CCC(=O)ON1C(=O)CCC1=O ; *NC(=O)CCC(=O)ON1C(=O)CCC1=O ; *OC(=O)CCCC(=O)ON1C(=O)CCC1=O ; *NC(=O)CCCC(=O)ON1C(=O)CCC1=O ; *Nc1nc(Cl)nc(CCl)n1]
R′ is C₁-C₆alkyl;
n is 0, 1, or 2; and
L₃ is a bond, C₁-C₆alkylene, C₁-C₆heteroalkylene, C₃-C₈cycloalkylene, C₆-C₁₄arylene, or 5- or 6-membered heterocyclylene or polyethylene glycol.

57. The composition of claim 56, wherein each of the plurality of cross-linkers is N,N′-methylenebisacrylamide.

58. The composition of claim 57, wherein the polymeric chelator particles each include at least one group having the structure:

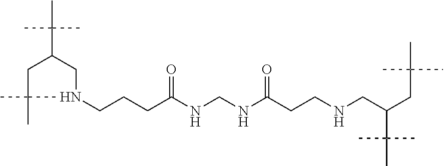

59. The composition of claim 46, wherein each of the plurality of cross-linkers is selected from:

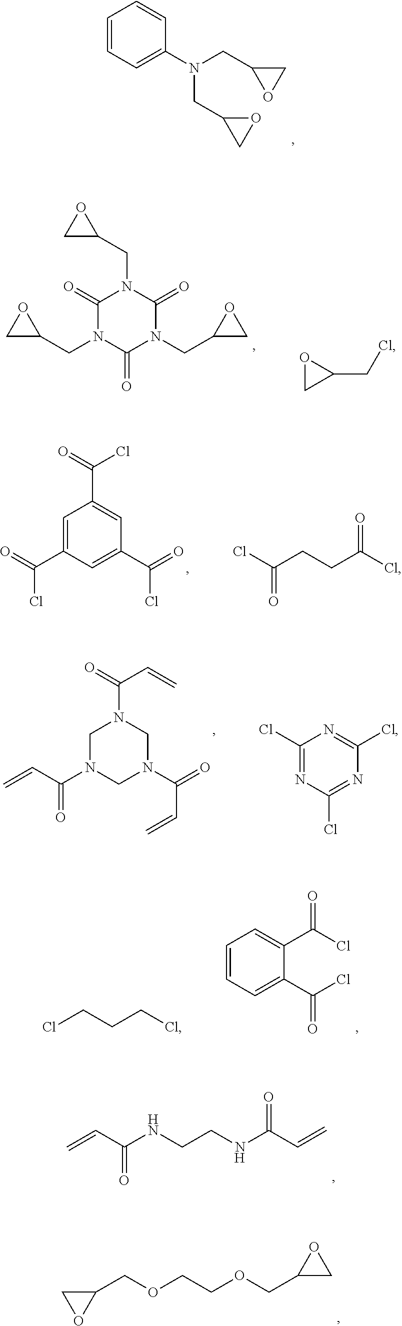

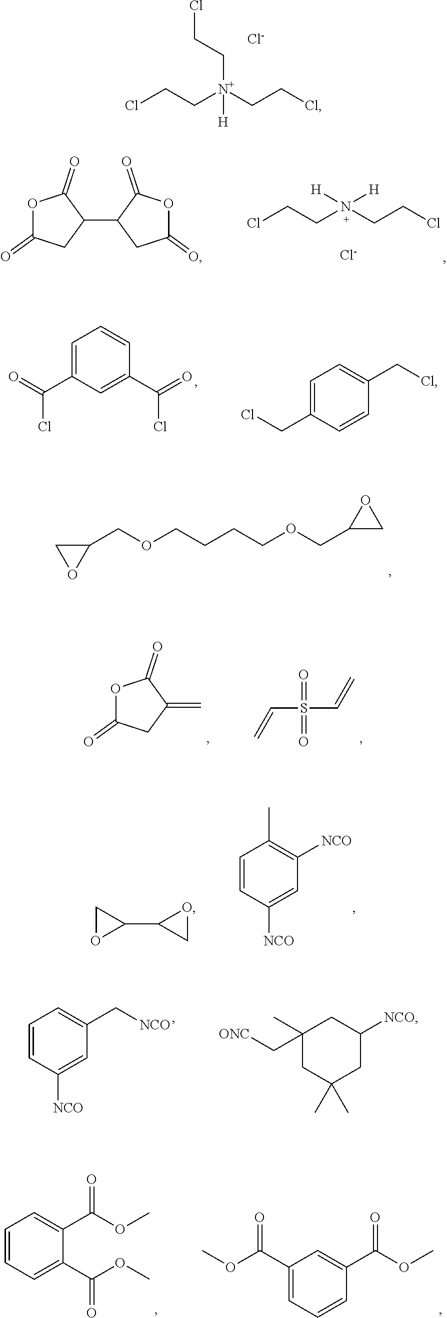

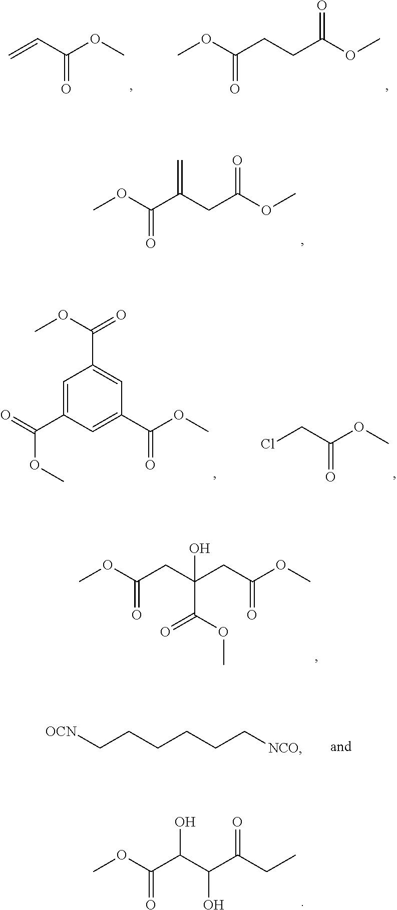

60. The composition of claim 46, wherein the plurality of cross-linkers are cross-linked to the polyamine polymer backbone chains at a density of 0.01% to 10% by molar ratio of total amines in the plurality of polyamine polymer backbone chains.

61. The composition of claim 60, wherein the plurality of cross-linkers are cross-linked at a density less than or equal to 1% by molar ratio of total amines in the plurality of polyamine polymer backbones chains.

62. The composition of claim 46, wherein the one or more chelators each comprise a phenyl group substituted with at least two hydroxyl groups.

63. The composition of claim 62, wherein the one or more chelators each comprise a phenyl group substituted with at least two hydroxyl groups, and the at least two hydroxyl groups include a vicinal diol.

64. The composition of claim 63, wherein the one or more chelators each comprise 2,3-dihydroxybenzoic acid.

65. The composition of claim 64, wherein the polymeric chelator particles each comprise at least one group having the structure: [chemical structure]
